(19) United States
(12) Patent Application Publication
(10) Pub. No.: US 2025/0334542 A1
(43) Pub. Date: Oct. 30, 2025

(54) SENSOR ELEMENT AND GAS SENSOR

(71) Applicant: NGK INSULATORS, LTD., Nagoya-shi (JP)

(72) Inventors: Shiho IWAI, Nagoya-shi (JP); Takayuki SEKIYA, Nisshin-shi (JP); Yusuke WATANABE, Nagoya-shi (JP)

(21) Appl. No.: 19/264,125

(22) Filed: Jul. 9, 2025

Related U.S. Application Data
(63) Continuation of application No. PCT/JP2024/000357, filed on Jan. 11, 2024.

(30) Foreign Application Priority Data
Jan. 26, 2023 (JP) 2023-010154

(51) Int. Cl. G01N 27/409; G01N 27/41; G01N 27/419

(52) U.S. Cl. CPC G01N 27/409; G01N 27/41; G01N 27/419

(57) ABSTRACT

A sensor element for detecting a concentration of a specific gas in a measurement-object gas, the sensor element includes: an element body including an oxygen-ion-conductive solid electrolyte layer, and including a measurement-object gas flow section inside that introduces the measurement-object gas and allows the measurement-object gas to flow through; an adjustment pump cell including an inner adjustment electrode provided in an oxygen concentration adjustment chamber of the measurement-object gas flow section; and a measurement pump cell including a measurement electrode provided in a measurement chamber that is located downstream of the oxygen concentration adjustment chamber in the measurement-object gas flow section; wherein, letting Ve [mm³] be a volume of the measurement electrode, and Vr [mm³] be a volume of the measurement chamber, and defining a volume ratio as Fv=Ve/(Vr−Ve), 0.05≤Fv≤0.21 is satisfied.

### CROSS-REFERENCE TO RELATED APPLICATION

This application is a continuation application of PCT/JP2024/000357, filed on Jan. 11, 2024, which claims the benefit of priority of Japanese Patent Application No. JP2023-010154, filed on Jan. 26, 2023, the entire contents of which are incorporated herein by reference.

### BACKGROUND OF THE INVENTION

### 1. Field of the Invention

The present invention relates to a sensor element and a gas sensor.

### 2. Description of the Related Art

Hitherto, a gas sensor that detects the concentration of a specific gas, such as NOx, in a measurement-object gas, such as the exhaust gas of an automobile, is known. For example, PTL 1 describes a gas sensor that comprises an element body that includes an oxygen-ion-conductive solid electrolyte layer, and is internally provided with a measurement-object gas flow section that introduces a measurement-object gas and causes the measurement-object gas to flow therethrough, an adjustment pump cell being configured to adjust an oxygen concentration in the oxygen concentration adjustment chamber of the measurement-object gas flow section, a measurement pump cell including an measurement electrode disposed in a measurement chamber located downstream of the oxygen concentration adjustment chamber in the measurement-object gas flow section, the measurement pump cell being configured to pump out oxygen, and a reference electrode disposed inside the element body so as to be in contact with a reference gas which serves as a reference for detection of a specific gas concentration in the measurement-object gas. When using this gas sensor to detect the NOx concentration, first, the oxygen concentration in the measurement-object gas is adjusted in the oxygen concentration adjustment chamber by the adjustment pump cell. Next, the NOx in the measurement-object gas with the oxygen concentration adjusted is reduced in the measurement chamber. Then, the measurement pump cell is controlled so that a measurement voltage generated across the measurement electrode and the reference electrode reaches a normal time target value, the oxygen in the measurement chamber is pumped out, and the NOx concentration in the measurement-object gas is detected based on pump current Ip2 which flows then in the measurement pump cell. PTL 1 describes a start-up time measurement pump control process of pumping out oxygen in the measurement chamber at a start-up time of the sensor element by controlling the measurement pump cell so that the measurement voltage reaches a start-up time target value higher than the normal time target value. A light-off time can be shortened by performing the start-up time measurement pump control process. The light-off time is the time from the start of sensor element startup to the time when the value of pump current Ip2 corresponds to the NOx concentration in the measurement-object gas. The light-off time varies depending on the length of time required to remove oxygen present in the measurement chamber before the start-up of the sensor element.

### CITATION LIST

### Patent Literature

PTL 1: Japanese Unexamined Patent Application Publication No. 2022-091669

### SUMMARY OF THE INVENTION

In such a gas sensor, regardless of whether or not the start-up time measurement pump control process described above is performed, the smaller a volume of the measurement electrode, the shorter the light-off time tends to be. However, the smaller the volume of the measurement electrode, the more likely the measurement electrode is to deteriorate.

The present invention has been devised to solve such a problem, and it is a main object to suppress the light-off time from becoming longer while suppressing deterioration of the measurement electrode.

The present invention employs the following device to achieve the above-described main object.

[1]A sensor element according to the present invention is a sensor element for detecting a concentration of a specific gas in a measurement-object gas, the sensor element comprising: an element body including an oxygen-ion-conductive solid electrolyte layer, and including a measurement-object gas flow section inside that introduces the measurement-object gas and allows the measurement-object gas to flow through; an adjustment pump cell including an inner adjustment electrode provided in an oxygen concentration adjustment chamber of the measurement-object gas flow section, and being configured to adjust an oxygen concentration in the oxygen concentration adjustment chamber; and a measurement pump cell including a measurement electrode provided in a measurement chamber that is located downstream of the oxygen concentration adjustment chamber in the measurement-object gas flow section, and adjusting an oxygen concentration in the measurement chamber; wherein, letting Ve [mm³] be a volume of the measurement electrode, and Vr [mm³] be the volume of a measurement chamber, and defining a volume ratio as Fv=Ve/(Vr−Ve), 0.05≤Fv≤0.21 is satisfied.

In this sensor element, letting Ve [mm³] be the volume of the measurement electrode, and Vr [mm³] be the volume of the measurement chamber, and defining the volume ratio as Fv=Ve/(Vr−Ve), 0.05≤Fv≤0.21 is satisfied. The volume ratio Fv corresponds to the ratio of the volume Ve of the measurement electrode to a volume of a space portion in the measurement chamber. In this sensor element, the deterioration of the measurement electrode can be suppressed by setting the volume ratio Fv to 0.05 or more. In addition, by setting the volume ratio Fv to 0.21 or less, the light-off time can be suppressed from becoming longer. The present inventors have demonstrated these facts through experiments, analyses, and the like. Therefore, in this sensor element, it is possible to suppress the light-off time from becoming longer while suppressing deterioration of the measurement electrode.

[2] In the above-described sensor element (the sensor element according to [1] above), letting a height direction be a direction perpendicular to an arrangement surface on which the measurement electrode are arranged in the measurement chamber, He [mm] be a height of the measurement electrode, and Hr [mm] be a height of the measurement chamber, and defining a height ratio as Fh=He/Hr, Fh<0.3 may be satisfied, and letting Se [mm³] be an area of the contact surface of the measurement electrode with the arrangement surface, Sr [mm³] be an area of the arrangement surface, and defining an area ratio as Sh=Se/Sr, Sh<0.8 may be satisfied.

[3] In the above-described sensor element (the sensor element according to [1] or [2] above), only one surface of the measurement electrode may be in contact with an inner surface of the measurement chamber. In this way, compared to when two or more surfaces of the measurement electrode are in contact with inner surfaces of the measurement chamber, the area of the measurement electrode exposed inside the measurement chamber is larger, thereby increasing the oxygen pumping speed of the measurement pump cell. Therefore, since the oxygen present in the measurement chamber before the start-up of the sensor element can be removed from the measurement chamber in a shorter time, it is possible to further suppress the light-off time from becoming longer.

[4] In the above-described sensor element (the sensor element according to any one of [1] to [3] above), the measurement electrode may be a porous body, and letting Ve′ [mm³] be a volume based on the external dimensions of the measurement electrode, P [%] be a porosity of the measurement electrode, the volume Ve may be expressed as Ve=Ve′*(1−P/100).

[5] In the above-described sensor element (the sensor element according to any one of [1] to [4] above), the measurement electrode may contain at least one of Pt or Rh.

[6] In the above-described sensor element (the sensor element according to any one of [1] to [5] above), the oxygen concentration adjustment chamber may include a first internal cavity, and a second internal cavity provided downstream of the first internal cavity; the inner adjustment electrode may include a main pump electrode provided in the first internal cavity, and an auxiliary pump electrode provided in the second internal cavity; and the adjustment pump cell may include a main pump cell having the main pump electrode and being configured to adjust an oxygen concentration in the first internal cavity, and a auxiliary pump cell having the auxiliary pump electrode and being configured to adjust an oxygen concentration in the second internal cavity.

[7]A gas sensor according to the present invention comprises the sensor element according to any one of [1] to [6]. Thus, the gas sensor produces the same advantageous effect as those produced by the above sensor element. For example, it is possible to obtain an effect of suppressing the light-off time from becoming longer while suppressing deterioration of the measurement electrode.

### BRIEF DESCRIPTION OF THE DRAWINGS

FIG. 1 is a cross-sectional schematic view schematically showing an example of a configuration of a gas sensor 100.

FIG. 2 is a partially enlarged view of the area around a measurement electrode 44 in the spacer layer 5 of FIG. 1, showing as viewed from above.

FIG. 3 is a block diagram showing an electrical connection relationship between a control apparatus 95 and relevant elements including cells.

FIG. 4 is a graph showing the relationship between a volume ratio Fv and a normalized change rate ΔIp2s.

FIG. 5 is a graph showing the relationship between a volume ratio Fv and a normalized light-off time.

### DETAILED DESCRIPTION OF THE INVENTION

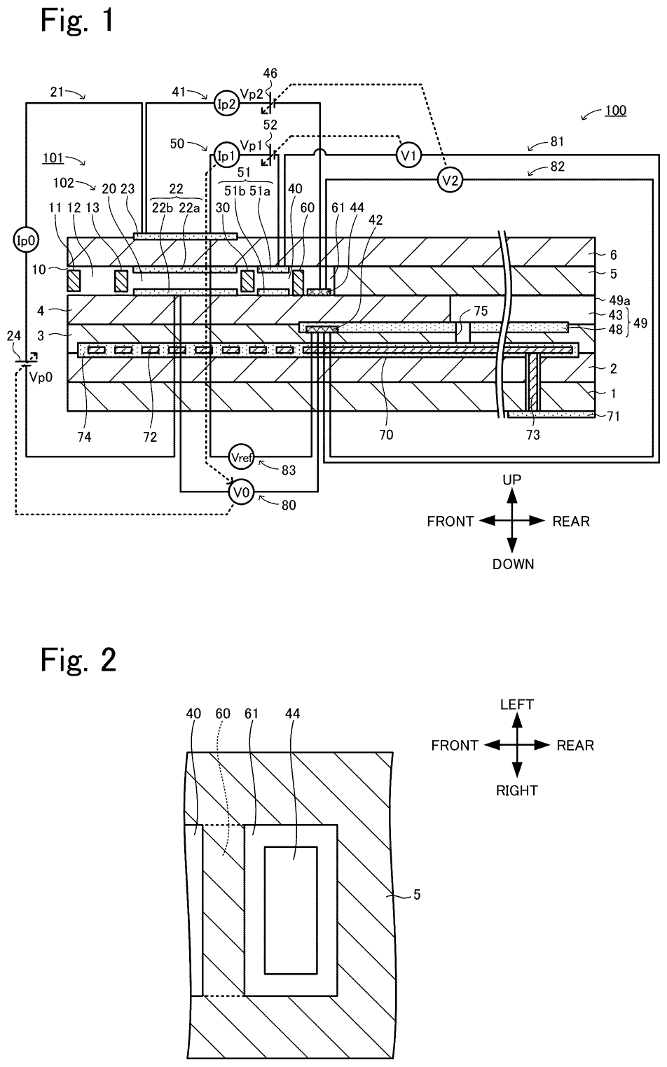

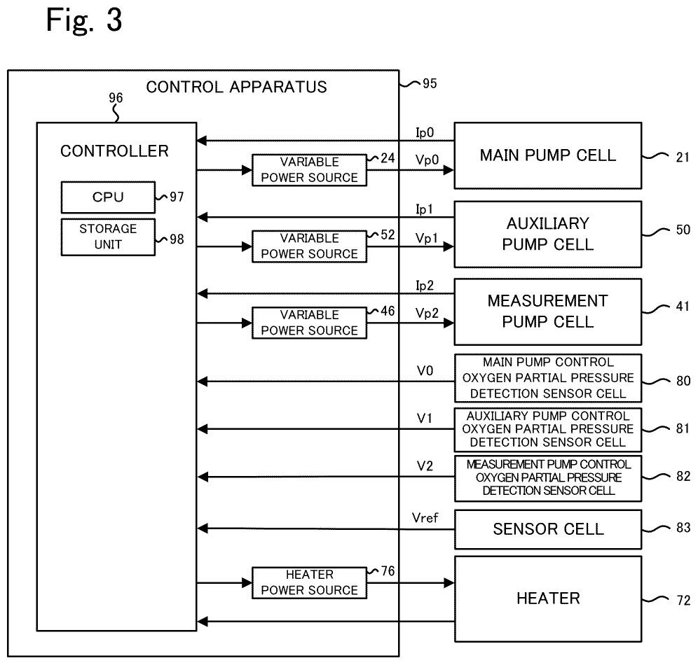

Next, an embodiment of the present invention will be described using the drawings. FIG. 1 is a cross-sectional schematic view schematically showing an example of the configuration of gas sensor 100 which is an embodiment of the present invention. FIG. 2 is a partially enlarged view of the area around a measurement electrode 44 in the spacer layer 5 of FIG. 1, showing as viewed from above. In addition, in FIG. 2, the fourth diffusion control section 60 is shown by a dotted line for reference. FIG. 3 is a block diagram showing an electrical connection relationship between a control apparatus 95, cells and a heater 72. The gas sensor 100 is installed in a pipe, such as an exhaust gas pipe of an internal combustion engine, for example. The gas sensor 100 uses the exhaust gas from an internal combustion engine as the measurement-object gas, and detects specific gas concentration which is the concentration of a specific gas such as NOx or ammonia in the measurement-object gas. In the present embodiment, the gas sensor 100 measures a NOx concentration as the specific gas concentration. The gas sensor 100 has a sensor element 101 including a long rectangular parallelepiped shape element body 102, cells 21, 41, 50, 80 to 83 included in the sensor element 101, a heater portion 70 provided inside the sensor element 101, and a control apparatus 95 that includes variable power supplies 24, 46, 52 and a heater power source 76, and controls the entire gas sensor 100.

The element body 102 is a layered body in which six layers, that is, a first substrate layer 1, a second substrate layer 2, a third substrate layer 3, a first solid electrolyte layer 4, a spacer layer 5, and a second solid electrolyte layer 6, each made up of an oxygen-ion-conductive solid electrolyte layer made of zirconia (ZrO₂) or the like, are laminated in this order from a lower side in the drawing. The solid electrolyte forming these six layers is a dense, airtight one. The element body 102 is manufactured by, for example, applying predetermined processing, printing of a circuit pattern, and the like on a ceramic green sheet corresponding to each layer, then laminating those sheets, and further firing the sheets to be integrated.

At a tip end portion side of the sensor element 101 (the element body 102) (left end portion side in FIG. 1), a gas inlet port 10, a first diffusion control section 11, a buffer space 12, a second diffusion control section 13, a first internal cavity (an oxygen concentration adjustment chamber) 20, a third diffusion control section 30, a second internal cavity (then oxygen concentration adjustment chamber) 40, a fourth diffusion control section 60, and a third internal cavity (a measurement chamber) 61, are formed adjacent to each other so as to communicate with each other in this order between the lower surface of the second solid electrolyte layer 6 and the upper surface of the first solid electrolyte layer 4.

The gas inlet port 10, the buffer space 12, the first internal cavity 20, the second internal cavity 40, and the third internal cavity 61 are spaces of which top parts, bottom parts, and side parts, provided by hollowing the spacer layer 5, are respectively defined by the lower surface of the second solid electrolyte layer 6, the upper surface of the first solid electrolyte layer 4, and the side surface of the spacer layer 5 inside the sensor element 101.

Each of the first diffusion control section 11, the second diffusion control section 13, and the third diffusion control section 30 is provided as two laterally long slits (openings of which the longitudinal direction is a direction perpendicular to the drawing). The fourth diffusion control section 60 provided as a single laterally long slit (an opening of which the longitudinal direction is a direction perpendicular to the drawing) formed as a clearance from the lower surface of the second solid electrolyte layer 6. A part from the gas inlet port 10 to the third internal cavity 61 is also referred to as measurement-object gas flow portion.

The sensor element 101 (element body 102) includes a reference-gas introduction portion 49 that allows the reference gas to flow from outside the sensor element 101 to a reference electrode 42 in the measurement of NOx concentration. The reference-gas introduction portion 49 has a reference-gas introduction space 43 and a reference-gas introduction layer 48. The reference gas introduction space 43 is a space that is provided inward from a rear end face of the sensor element 101. The reference-gas introduction space 43 is provided at a position between the upper surface of the third substrate layer 3 and the lower surface of the spacer layer 5 and has lateral sides defined by the side surfaces of the first solid electrolyte layer 4. The reference-gas introduction space 43 has an opening at the rear end face of the sensor element 101. This opening functions as an entrance 49a of the reference-gas introduction portion 49. The reference gas is to be introduced into the reference-gas introduction space 43 through the entrance 49a. The reference-gas introduction portion 49 introduces the reference gas to the reference electrode 42 while applying a predetermined diffusion resistance to the reference gas received through the entrance 49a. In the present embodiment, the reference gas is ambient air.

The reference-gas introduction layer 48 is disposed between the upper surface of the third substrate layer 3 and the lower surface of the first solid electrolyte layer 4. The reference-gas introduction layer 48 is a porous body composed of a ceramic material such as alumina. A part of the upper surface of the reference-gas introduction layer 48 is exposed in the reference-gas introduction space 43. The reference-gas introduction layer 48 is provided over the reference electrode 42. The reference-gas introduction layer 48 allows the reference gas to flow from the reference-gas introduction space 43 to the reference electrode 42.

The reference electrode 42 is an electrode formed in such a manner in which the reference electrode 42 is sandwiched by the upper surface of the third substrate layer 3 and the first solid electrolyte layer 4. As described above, the reference gas inlet layer 48 that communicates with the reference gas inlet space 43 is provided around the reference electrode 42. As will be described later, it is possible to measure an oxygen concentration (oxygen partial pressure) in the first internal cavity 20, an oxygen concentration (oxygen partial pressure) in the second internal cavity 40, and an oxygen concentration (oxygen partial pressure) in the third internal cavity 61 by using the reference electrode 42.

In the measurement-object gas flow portion, the gas inlet port 10 is a portion that is open to an external space, and a measurement-object gas is taken into the sensor element 101 from the external space through the gas inlet port 10. The first diffusion control section 11 is a portion that applies predetermined diffusion resistance to a measurement-object gas taken in through the gas inlet port 10. The buffer space 12 is a space provided to guide the measurement-object gas introduced from the first diffusion control section 11 to the second diffusion control section 13. The second diffusion control section 13 is a portion that applies predetermined diffusion resistance to the measurement-object gas introduced from the buffer space 12 into the first internal cavity 20. When the measurement-object gas is introduced from the outside of the sensor element 101 into the first internal cavity 20, the measurement-object gas rapidly taken into the sensor element 101 through the gas inlet port 10 due to pressure fluctuations of the measurement-object gas in the external space (due to pulsation of exhaust pressure when the measurement-object gas is the exhaust gas of an automobile) is not directly introduced into the first internal cavity 20 but, after pressure fluctuations of the measurement-object gas are cancelled out through the first diffusion control section 11, the buffer space 12, and the second diffusion control section 13, the measurement-object gas is introduced into the first internal cavity 20. With this configuration, pressure fluctuations of the measurement-object gas introduced into the first internal cavity 20 are almost ignorable. The first internal cavity 20 is provided as a space used to adjust an oxygen partial pressure in the measurement-object gas introduced through the second diffusion control section 13. The oxygen partial pressure is adjusted by the operation of a main pump cell 21.

The main pump cell 21 is an electrochemical pump cell constituted of an inner pump electrode 22 including a ceiling electrode portion 22a disposed on the lower surface of the second solid electrolyte layer 6 over substantially the entirety of an area that faces the first internal cavity 20; an outer pump electrode 23 disposed on the upper surface of the second solid electrolyte layer 6 over an area that corresponds to the ceiling electrode portion 22a in such a manner as to be exposed to the outside of the sensor element 101; and the second solid electrolyte layer 6, the spacer layer 5, and the first solid electrolyte layer 4 that form a current path between the electrodes 22 and 23.

The inner pump electrode 22 is formed over the upper and lower solid electrolyte layers (the second solid electrolyte layer 6 and the first solid electrolyte layer 4) defining the first internal cavity 20, and the spacer layer 5 providing a side wall. Specifically, the ceiling electrode portion 22a is formed on the lower surface of the second solid electrolyte layer 6, providing a ceiling surface of the first internal cavity 20, a bottom electrode portion 22b is formed on the upper surface of the first solid electrolyte layer 4, providing a bottom surface, a side electrode portion (not shown) is formed on the side wall surface (inner surface) of the spacer layer 5, making both side wall portions of the first internal cavity 20, so as to connect those ceiling electrode portion 22a and the bottom electrode portion 22b, and the inner pump electrode 22 is disposed with a structure in a tunnel form at a portion where the side electrode portion is disposed.

By passing a pump current Ip0 in a positive direction or a negative direction between the inner pump electrode 22 and the outer pump electrode 23 by applying a desired voltage Vp0 between the inner pump electrode 22 and the outer pump electrode 23, the main pump cell 21 is capable of pumping out oxygen in the first internal cavity 20 to the external space or pumping oxygen in the external space into the first internal cavity 20.

In order to detect an oxygen concentration (oxygen partial pressure) in an atmosphere in the first internal cavity 20, an electrochemical sensor cell, that is, a main pump control oxygen partial pressure detection sensor cell 80, is made up of the inner pump electrode 22, the second solid electrolyte layer 6, the spacer layer 5, the first solid electrolyte layer 4, the third substrate layer 3, and the reference electrode 42.

An oxygen concentration (oxygen partial pressure) in the first internal cavity 20 is found by measuring an electromotive force (voltage V0) in the main pump control oxygen partial pressure detection sensor cell 80. In addition, the pump current Ip0 is controlled by executing feedback control over the voltage Vp0 of a variable power source 24 such that the voltage V0 becomes a target value. With this configuration, it is possible to maintain the oxygen concentration in the first internal cavity 20 at a predetermined constant value.

The third diffusion control section 30 is a portion that applies predetermined diffusion resistance to a measurement-object gas of which the oxygen concentration (oxygen partial pressure) is controlled by operation of the main pump cell 21 in the first internal cavity 20 to guide the measurement-object gas to the second internal cavity 40.

The second internal cavity 40 is provided as a space used to further adjust the oxygen partial pressure by using an auxiliary pump cell 50 for the measurement-object gas adjusted in the oxygen concentration (oxygen partial pressure) in the first internal cavity 20 in advance and then introduced through the third diffusion control section 30. With this configuration, it is possible to highly accurately maintain the oxygen concentration in the second internal cavity 40 at a constant value, so it is possible to measure a highly accurate NOx concentration with the gas sensor 100.

The auxiliary pump cell 50 is an auxiliary electrochemical pump cell made up of an auxiliary pump electrode 51 having a ceiling electrode portion 51a provided substantially all over the lower surface of the second solid electrolyte layer 6, facing the second internal cavity 40, the outer pump electrode 23 (not limited to the outer pump electrode 23, and an adequate electrode outside the sensor element 101 may be used), the second solid electrolyte layer 6, the spacer layer 5, and the first solid electrolyte layer 4.

The auxiliary pump electrode 51 is disposed in the second internal cavity 40 with a structure in a similar tunnel form to that of the inner pump electrode 22 provided in the above-described first internal cavity 20. In other words, the auxiliary pump electrode 51 has such a structure in a tunnel form that a ceiling electrode portion 51a is formed on the second solid electrolyte layer 6 providing the ceiling surface of the second internal cavity 40, a bottom electrode portion 51b is formed on the first solid electrolyte layer 4 providing the bottom surface of the second internal cavity 40, a side electrode portion (not shown) that couples those ceiling electrode portion 51a and bottom electrode portion 51b is formed on each of both wall surfaces of the spacer layer 5, providing a side wall of the second internal cavity 40.

By applying a desired voltage Vp1 between the auxiliary pump electrode 51 and the outer pump electrode 23, the auxiliary pump cell 50 is capable of pumping out oxygen in an atmosphere in the second internal cavity 40 to the external space or pumping oxygen from the external space into the second internal cavity 40

In order to control an oxygen partial pressure in an atmosphere in the second internal cavity 40, an electrochemical sensor cell, that is, an auxiliary pump control oxygen partial pressure detection sensor cell 81, is made up of the auxiliary pump electrode 51, the reference electrode 42, the second solid electrolyte layer 6, the spacer layer 5, the first solid electrolyte layer 4, and the third substrate layer 3.

The auxiliary pump cell 50 performs pumping with a variable power source 52 of which the voltage is controlled in accordance with an electromotive force (voltage V1) detected by the auxiliary pump control oxygen partial pressure detection sensor cell 81. With this configuration, the oxygen partial pressure in an atmosphere in the second internal cavity 40 is controlled to a low partial pressure that substantially does not influence measurement of NOx.

Together with this, its pump current Ip1 is used to control the electromotive force of the main pump control oxygen partial pressure detection sensor cell 80. Specifically, the pump current Ip1 is input to the main pump control oxygen partial pressure detection sensor cell 80 as a control signal, and the gradient of the oxygen partial pressure in the measurement-object gas to be introduced from the third diffusion control section 30 into the second internal cavity 40 is controlled to be constantly unchanged by controlling the above-described target value of the voltage V0. When used as a NOx sensor, the oxygen concentration in the second internal cavity 40 is maintained at a constant value of about 0.001 ppm by the functions of the main pump cell 21 and auxiliary pump cell 50.

The fourth diffusion control section 60 is a portion that applies predetermined diffusion resistance to measurement-object gas of which the oxygen concentration (oxygen partial pressure) is controlled by operation of the auxiliary pump cell 50 in the second internal cavity 40 to guide the measurement-object gas to the third internal cavity 61. The fourth diffusion control section 60 plays a role in limiting the amount of NOx flowing into the third internal cavity 61.

The third internal cavity 61 is provided as a space used to perform a process related to measurement of a nitrogen oxide (NOx) concentration in a measurement-object gas on the measurement-object gas adjusted in oxygen concentration (oxygen partial pressure) in the second internal cavity 40 in advance and then introduced through the fourth diffusion control section 60. Measurement of a NOx concentration is mainly performed by operation of a measurement pump cell 41 in the third internal cavity 61.

The measurement pump cell 41 measures a NOx concentration in the measurement-object gas in the third internal cavity 61. The measurement pump cell 41 is an electrochemical pump cell made up of a measurement electrode 44 provided on the upper surface of the first solid electrolyte layer 4, facing the third internal cavity 61, the outer pump electrode 23, the second solid electrolyte layer 6, the spacer layer 5, and the first solid electrolyte layer 4. The measurement electrode 44 also functions as a NOx reduction catalyst that reduces NOx present in an atmosphere in the third internal cavity 61.

The measurement pump cell 41 is capable of pumping out oxygen produced as a result of decomposition of nitrogen oxides in an atmosphere around the measurement electrode 44 and detecting the amount of oxygen produced as a pump current Ip2.

In order to detect an oxygen partial pressure around the measurement electrode 44, an electrochemical sensor cell, that is, a measurement pump control oxygen partial pressure detection sensor cell 82, is made up of the first solid electrolyte layer 4, the third substrate layer 3, the measurement electrode 44, and the reference electrode 42. A variable power source 46 is controlled in accordance with an electromotive force (voltage V2) detected by the measurement pump control oxygen partial pressure detection sensor cell 82.

A measurement-object gas guided into the second internal cavity 40 reaches the measurement electrode 44 in the third internal cavity 61 through the fourth diffusion control section 60 in a situation in which the oxygen partial pressure is controlled. Nitrogen oxides in the measurement-object gas around the measurement electrode 44 are reduced (2NO→N₂+O₂) to produce oxygen. The produced oxygen is to be pumped by the measurement pump cell 41. At this time, the voltage Vp2 of the variable power source 46 is controlled such that the voltage V2 detected by the measurement pump control oxygen partial pressure detection sensor cell 82 is constant (target value). The amount of oxygen produced around the measurement electrode 44 is proportional to the concentration of nitrogen oxides in the measurement-object gas, so a nitrogen oxide concentration in the measurement-object gas is calculated by using the pump current Ip2 in the measurement pump cell 41.

When an oxygen partial pressure detection device is constructed as an electrochemical sensor cell by combining the measurement electrode 44, the first solid electrolyte layer 4, the third substrate layer 3, and the reference electrode 42, an electromotive force according to the difference between the amount of oxygen produced by reduction of the NOx component in the atmosphere around the measurement electrode 44, and the amount of oxygen contained in the reference gas can be detected, and accordingly, the concentration of the NOx component in the measurement-object gas can be determined.

In addition, an electrochemical sensor cell 83 is made up of the second solid electrolyte layer 6, the spacer layer 5, the first solid electrolyte layer 4, the third substrate layer 3, the outer pump electrode 23, and the reference electrode 42, and it is possible to detect an oxygen partial pressure in a measurement-object gas outside the sensor by using an electromotive force (voltage Vref) obtained by the sensor cell 83.

In the gas sensor 100 having such a configuration, a measurement-object gas of which the oxygen partial pressure is maintained at a constantly unchanged low value (a value that substantially does not influence measurement of NOx) is supplied to the measurement pump cell 41 by operating the main pump cell 21 and the auxiliary pump cell 50. Therefore, it is possible to find a NOx concentration in the measurement-object gas in accordance with a pump current Ip2 that flows as a result of pumping out oxygen, produced by reduction of NOx, by the measurement pump cell 41 substantially in proportion to a NOx concentration in the measurement-object gas.

Here, the electrodes 22, 23, 42, 44, and 51 will be described. The inner pump electrode 22, the auxiliary pump electrode 51, and the measurement electrode 44 each contain Class 1 noble metal with catalytic activity. The Class 1 noble metal may be at least one of Pt, Rh, Ir, Ru, and Pd, for example. The outer pump electrode 23 and the reference electrode 42 each also contain Class 1 noble metal. The inner pump electrode 22 and the auxiliary pump electrode 51 each further contain Class 2 noble metal that reduces the catalytic activity of the Class 1 noble metal on the specific gas (NOx). Thus, the reducing ability of each of the inner pump electrode 22 and the auxiliary pump electrode 51 with respect to the NOx component in the measurement-object gas is weakened. The Class 2 noble metal may be Au, for example. The measurement electrode 44 does not contain any Class 2 noble metal. Thus, the reducing ability of the measurement electrode 44 with respect to the NOx component in the measurement-object gas is made higher than that of the inner pump electrode 22 and the auxiliary pump electrode 51. The measurement electrode 44 preferably contains at least one of Pt and Rh among Class 1 noble metals, or may contain both Pt and Rh. The outer pump electrode 23 and the reference electrode 42 each preferably contain none of Class 2 noble metals. The electrodes 22, 23, 42, 44, and 51 are each preferably a cermet that contains noble metal and oxygen-ion-conductive oxide (such as ZrO₂). Preferably, the electrodes 22, 23, 42, 44, and 51 are each a porous body. In the present embodiment, the inner pump electrode 22 and the auxiliary pump electrode 51 are each a porous cermet electrode composed of Pt and ZrO₂ with 1% of Au. The outer pump electrode 23 and the reference electrode 42 are each a porous cermet electrode composed of Pt and ZrO₂. The measurement electrode 44 is a porous cermet electrode composed of Pt, Rh, and ZrO₂.

The sensor element 101 includes the heater portion 70 that plays a role in temperature adjustment for maintaining the temperature of the sensor element 101 by heating in order to increase the oxygen ion conductivity of the solid electrolyte. The heater portion 70 includes a heater connector electrode 71, a heater 72, a through-hole 73, a heater insulating layer 74, and a pressure release hole 75.

The heater connector electrode 71 is an electrode formed in such a manner as to be in contact with the lower surface of the first substrate layer 1. Connection of the heater connector electrode 71 to an heater power source 76 (see FIG. 3) allows electric power to be supplied from the heater power source 76 to the heater portion 70.

The heater 72 is an electric resistor formed in such a manner as to be sandwiched by the second substrate layer 2 and the third substrate layer 3 from upper and lower sides. The heater 72 is connected to the heater connector electrode 71 via the through-hole 73, and is supplied with electric power from a heater power source 76 to generate heat to increase and retain the temperature of the solid electrolyte forming the sensor element 101.

The heater 72 is embedded all over the region from the first internal cavity 20 to the third internal cavity 61, and is capable of adjusting the overall sensor element 101 to a temperature at which the solid electrolyte is activated.

The heater insulating layer 74 is an electrically insulating layer formed of an insulating material, such as alumina, on the top and lower surfaces of the heater 72. The heater insulating layer 74 is formed for the purpose of obtaining an electrical insulation property between the second substrate layer 2 and the heater 72 and an electrical insulation property between the third substrate layer 3 and the heater 72.

The pressure release hole 75 is a portion provided so as to extend through the third substrate layer 3 and the reference gas inlet layer 48 and communicate with the reference gas inlet space 43. The pressure release hole 75 is formed for the purpose of easing an increase in internal pressure resulting from an increase in temperature in the heater insulating layer 74.

As illustrated in FIG. 3, the control apparatus 95 includes the above-described variable power sources 24, 46, and 52, the above-described heater power source 76, and a controller 96. The controller 96 is a microprocessor including a CPU 97, a storage unit 98, and so forth. The storage unit 98 is an information-rewritable nonvolatile memory and is capable of storing, for example, various programs and various data. The controller 96 is configured to receive the voltage V0 of the main-pump-control oxygen-partial-pressure detection sensor cell 80, the voltage V1 of the auxiliary-pump-control oxygen-partial-pressure detection sensor cell 81, the voltage V2 of the measurement-pump-control oxygen-partial-pressure detection sensor cell 82, the voltage Vref of the sensor cell 83, the pump current Ip0 flowing through the main pump cell 21, the pump current Ip1 flowing through the auxiliary pump cell 50, and the pump current Ip2 flowing through the measurement pump cell 41. The controller 96 is configured to output control signals to the variable power sources 24, 46, and 52 and thus control the voltages Vp0, Vp1, and Vp2 that are to be output by the variable power sources 24, 46, and 52, thereby controlling the main pump cell 21, the measurement pump cell 41, and the auxiliary pump cell 50. The controller 96 is configured to output a control signal to the heater power source 76, thereby controlling the electric power to be supplied from the heater power source 76 to the heater 72. The storage unit 98 further stores target values V0*, V1*, V2*, and the like, to be described below. The CPU 97 of the controller 96 is configured to refer to the target values V0*, V1*, and V2* and thus control the pump cells 21, 41, and 50.

The controller 96 executes an auxiliary pump control process of controlling the auxiliary pump cell 50 so that the oxygen concentration in the second internal cavity 40 reaches a target concentration. Specifically, the controller 96 controls the auxiliary pump cell 50 by executing feedback control on the voltage Vp1 of the variable power source 52 so that the voltage V1 reaches a constant value (referred to as target value V1*). The target value V1* is defined as the value that causes the oxygen concentration in the second internal cavity 40 to reach a predetermined low oxygen concentration that does not substantially affect measurement of NOx.

The controller 96 executes a main pump control process of controlling the main pump cell 21 so that the pump current Ip1 flowing when the oxygen concentration in the second internal cavity 40 is adjusted by the auxiliary pump cell 50 in the auxiliary pump control process reaches a target current (referred to as target value Ip1*). Specifically, the controller 96 sets (feedback-controls) a target value (referred to as a target value V0*) of the voltage V0 based on the pump current Ip1 so that the pump current Ip1 caused to flow by the voltage Vp1 reaches the constant target current Ip1*. The controller 96 then performs feedback control on the voltage Vp0 of the variable power source 24 so that the voltage V0 reaches the target value V0* (in other words, the oxygen concentration in the first internal cavity 20 reaches the target concentration). The gradient of oxygen partial pressure in the measurement-object gas to be introduced from the third diffusion control section 30 into the second internal cavity 40 is made unchanged constantly by the main pump control process. The target value V0* is set to a value which causes the oxygen concentration in the first internal cavity 20 to be higher than 0% and reach a low oxygen concentration. The pump current Ip0 which flows during the main pump control process varies according to the oxygen concentration in the measurement-object gas (that is, the measurement-object gas in the vicinity of the sensor element 101) which flows into the measurement-object gas flow portion through the gas inlet port 10. Thus, the controller 96 can also detect the oxygen concentration in the measurement-object gas based on the pump current Ip0.

The main pump control process and the auxiliary pump control process described above are also collectively referred as an adjustment pump control process. The first internal cavity 20 and the second internal cavity 40 are also collectively referred as an oxygen concentration adjustment chamber. The main pump cell 21 and the auxiliary pump cell 50 are also collectively referred as an adjustment pump cell. The controller 96 executes the adjustment pump control process, thus the adjustment pump cell adjusts the oxygen concentration in the oxygen concentration adjustment chamber.

In addition, the controller 96 executes a measurement pump control process of controlling the measurement pump cell 41 so that the voltage V2 reaches a constant value (referred to as a target value V2*) (in other words, so that the oxygen concentration in the third internal cavity 61 reaches a predetermined low concentration). Specifically, the controller 96 controls the measurement pump cell 41 by performing feedback control on the voltage Vp2 of the variable power source 46 so that the voltage V2 reaches the target value V2*. Oxygen is pumped out from the third internal cavity 61 by the measurement pump control process.

Execution of the measurement pump control process causes oxygen to be pumped out from the third internal cavity 61 so that the oxygen produced due to reduction of NOx in the measurement-object gas in the third internal cavity 61 become substantially zero. The controller 96 obtains a pump current Ip2 as a detected value corresponding to the oxygen produced in the third internal cavity 61 from the specific gas (in this case, NOx), and calculates the NOx concentration in the measurement-object gas based on the pump current Ip2.

The storage unit 98 stores a relational expression (for example, an expression of a linear function or a quadratic function) or a map as a correspondence relationship between the pump current Ip2 and the NOx concentration. Such a relational expression or map can be determined in advance by an experiment.

The controller 96 performs a heater control process of controlling the heater 72 by outputting a control signal to the heater power source 76 so that the temperature of the heater 72 reaches a target temperature (for example, 800° C.). Here, the temperature of the heater 72 can be expressed as a linear function of the resistance value of the heater 72. Thus, in the heater control process, the controller 96 calculates the resistance value of the heater 72 as a value (a value convertible to the temperature) regarded as the temperature of the heater 72, and performs feedback control on the heater power source 76 so that the calculated resistance value reaches a target resistance value (a resistance value corresponding to the target temperature). The controller 96 obtains, for example, the voltage of the heater 72 and the current flowing through the heater 72, and can calculate the resistance value of the heater 72 based on the obtained voltage and current. The controller 96 may calculate the resistance value of the heater 72, for example, by 3-terminal method or 4-terminal method. When passing an electric current through the heater 72, the heater power source 76 adjusts the electric power supplied to the heater 72 by changing the value of the voltage to be applied to the heater 72 based on, for example, a control signal from the controller 96.

The control apparatus 95 inclusive of the variable power sources 24, 46, and 52, the heater power source 76, and so forth illustrated in FIG. 3, is actually connected to each electrode inside the sensor element 101 via lead wires not shown in the illustration, which are formed inside the sensor element 101, and the connector electrodes not shown in the illustration (only the heater connector electrode 71 is shown in FIG. 1), which are formed on the rear end side of the sensor element 101.

Now, an exemplary method of manufacturing the sensor element 101 included in the gas sensor 100 will be described. First, six non-calcinated ceramic green sheets each containing an oxygen-ion-conductive solid electrolyte, such as zirconia, as a ceramic component are prepared. In each of these green sheets, a plurality of sheet holes to be used for positioning during printing or stacking as well as necessary through-holes and the like are provided in advance. Furthermore, the green sheet that is to become the spacer layer 5 is preliminarily subjected to a punching process or the like in which a space that is to become the measurement-object gas flow section is provided. Likewise, the green sheet that is to become the first solid electrolyte layer 4 is subjected to a process for providing a space that is to become the reference-gas introduction space 43. Then, a pattern-printing process and a drying process for forming various patterns in the ceramic green sheets are performed in correspondence with the first substrate layer 1, the second substrate layer 2, the third substrate layer 3, the first solid electrolyte layer 4, the spacer layer 5, and the second solid electrolyte layer 6. Specific patterns to be formed include, for example, patterns that serve as electrodes such as the measurement electrode 44 described above, the lead wires connected to the electrodes, the reference-gas introduction layer 48, and the heater section 70. The pattern-printing process is performed in which a pattern-forming paste prepared in accordance with the properties required for an object to be formed is applied onto a green sheet by using a known screen printing technique. The drying process is performed by using a known drying technique. When the pattern-printing and the drying are completed, a printing process and a drying process are performed in which a bonding paste for stacking and bonding together the green sheets corresponding to the respective layers are printed and dried. Subsequently, the green sheets provided with the bonding paste are stacked in a predetermined order while being positioned at the sheet holes, a pressure bonding process is performed in which the green sheets are put under predetermined temperature and pressure conditions to be pressure bonded into a single layered body. The layered body thus obtained contains a plurality of sensor elements 101 therein. The layered body is cut into pieces each having the size of the sensor element 101. Then, a calcinating process is performed in which the cut layered body is calcinated at a predetermined calcination temperature, whereby a sensor element 101 is obtained.

After obtaining the sensor element 101 in this manner, a sensor assembly is manufactured in which the sensor element 101 is incorporated into an element sealing unit (not shown), and a protective cover and so forth is attached to the sensor assembly. Then, the sensor element 101 is electrically connected to the control apparatus 95, whereby the gas sensor 100 is obtained.

Here, a shape and dimensions of the third internal cavity 61 can be adjusted by adjusting a shape of a space formed by punching process for the spacer layer 5 and adjusting a thickness of the spacer layer 5. In addition, the pattern-forming paste of the measurement electrode 44 can be prepared by mixing, for example, a powder of the Class 1 noble metal (here, Pt and Rh), a powder of ZrO₂, and a binder. The shape and dimensions of the measurement electrode 44 can be adjusted by adjusting a viscosity of the paste and a shape of a screen printing mask.

Now, an exemplary usage of the gas sensor 100 will be described. The CPU 97 in the controller 96 first controls the heater power source 76 to supply electric power to the heater 72 such that the temperature of the heater 72 becomes a target temperature (800° C., for example). The CPU 97 controls the temperature of the heater 72 by, for example, acquiring a value (for example, the resistance value or current value of the heater 72) that is convertible into the temperature of the heater 72 and performing feedback control on the heater power source 76 based on the thus acquired value. When the temperature of the heater 72 reaches the target temperature (or near the target temperature), the CPU 97 starts controlling the above pump cells 21, 41, and 50 (the adjustment-pump control process and the measurement-pump control process) and acquiring the voltages V0, V1, V2, and Vref from the above sensor cells 80 to 83. When a measurement-object gas is introduced through the gas inlet 10 in this state, the measurement-object gas travels through the first diffusion control section 11, the buffer space 12, and the second diffusion control section 13 and reaches the first internal cavity 20. Then, the oxygen concentration in the measurement-object gas is adjusted in the first internal cavity 20 and the second internal cavity 40 by the main pump cell 21 and the auxiliary pump cell 50, and the measurement-object gas thus adjusted reaches the third internal cavity 61. Subsequently, the CPU 97 detects the NOx concentration in the measurement-object gas based on the acquired pump current Ip2 and the correspondence relationship stored in the storage unit 98.

In the present embodiment, letting Ve [mm³] be a volume of the measurement electrode 44, and Vr [mm³] be a volume of the third internal cavity 61 (one example of the measurement chamber), and defining a volume ratio as Fv=Ve/(Vr−Ve), 0.05≤Fv≤0.21 is satisfied. The volume ratio Fv corresponds to the ratio of the volume Ve of the measurement electrode 44 to a volume (Vr−Ve) of a space portion in the third internal cavity 61. When the measurement electrode 44 is a porous body, the volume Ve is defined as a volume of the measurement electrode 44 excluding pore portions. Specifically, letting Ve′ [mm³] be a volume based on the external dimensions of the measurement electrode 44, P [%] be a porosity of the measurement electrode 44, the volume Ve is expressed as Ve=Ve′*(1−P/100). In this case, a volume of the pore portions of the measurement electrode 44 is included in the volume (Vr−Ve) of the space portion in the third internal cavity 61. In the present embodiment, since the measurement electrode 44 has a substantially rectangular parallelepiped shape as illustrated in FIG. 1 and FIG. 2, the volume Ve′ is expressed by a product of a length of the measurement electrode 44 in the front-rear direction, a length of the measurement electrode 44 in the left-right direction, and a length of the measurement electrode 44 in the up-down direction. The porosity P of the measurement electrode 44 may be, for example, 5% or more and 50% or less. The porosity P may be 15% or more. In the present embodiment, since the third internal cavity 61 has a substantially rectangular parallelepiped shape as illustrated in FIG. 1 and FIG. 2, the volume Vr is expressed by a product of a length of the third internal cavity 61 in the front-rear direction, a length of the third internal cavity 61 in the left-right direction, and a length of the third internal cavity 61 in the up-down direction. The volume Ve of the measurement electrode 44 may be, for example, 0.003 mm³ or more and 0.015 mm³ or less. The volume Vr of the third internal cavity 61 may be, for example, 0.070 mm³ or more and 0.084 mm³ or less. The volume ratio Fv may be 0.06 or more, 0.15 or more, or 0.16 or more.

The porosity P of the measurement electrode 44 is defined as a value derived as follows by using an image (SEM image) obtained in an observation through a scanning electron microscope (SEM). First, a measurement object is cut to have a section. The section, regarded as an observation surface, is embedded with resin and is polished, whereby an observation sample is obtained. Subsequently, the observation surface of the observation sample is photographed by SEM photography (with a secondary electron image, an acceleration voltage of 15 kV, and a magnifying power of 1000, but if the magnifying power of 1000 is inappropriate, a magnifying power higher than 1000 and lower than or equal to 5000 is used), whereby a SEM image of the measurement object is obtained. Subsequently, the obtained image is analyzed, so that a threshold value is determined using the discriminant analysis method (Otsu binarization method) from a brightness distribution of brightness data on the pixels in the image. Then, each pixel in the image is binarized into an object section and a pore section based on the determined threshold value, and the area of the object section and the area of the pore section are calculated. Furthermore, the percentage of the area of the pore section relative to the overall area (i.e., the total area of the object section and the pore section) is derived as the porosity P [%]. The porosity P can be adjusted by adjusting the particle size and mixing amount of a pore-forming material mixed in the pattern-forming paste for the measurement electrode 44, for example.

Here, the measurement electrode 44 in the sensor element 101 deteriorates with use. Deterioration of the measurement electrode 44 includes, for example, oxidation of the Class 1 noble metal (e.g., Pt and Rh) contained in the measurement electrode 44, which makes the oxidized noble metal more likely to evaporate than before oxidation, thereby reducing the amount of the noble metal in the measurement electrode 44 and decreasing the catalytic activity of the measurement electrode 44. When the catalytic activity of the measurement electrode 44 decreases, the reduction of the specific gas (here, NOx) in the third internal cavity 61 is suppressed, so even if the NOx concentration is the same, the pump current Ip2 flowing becomes smaller, and the accuracy in detection of the specific gas concentration decreases. In contrast, in the sensor element 101 of the present embodiment, the deterioration of the measurement electrode 44 is suppressed by setting the volume ratio Fv to 0.05 or more. The present inventors have demonstrated this fact through experiments, analyses, and the like. The reason for this is considered to be as follows. The smaller the volume ratio Fv of the sensor element 101, the larger the volume (Vr−Ve) of the space portion in the third internal cavity 61 is relative to the volume Ve of the measurement electrode 44. Therefore, when the sensor element 101 is used, the amount of oxygen pumped out by the measurement pump cell 41 tends to increase, causing the pump current Ip2 to increase. If the pump current Ip2 is too large, the more likely the measurement electrode 44 is to deteriorate. In contrast, if the volume ratio Fv is 0.05 or more, the pump current Ip2 can be suppressed from becoming too large, and deterioration of the measurement electrode 44 can be suppressed.

In addition, when the gas sensor 100 is used, it takes time from the start of start-up of the sensor element 101 (e.g., the start of energizing the heater 72) until the value of the pump current Ip2 becomes a value corresponding to the specific gas concentration in the measurement-object gas (until the specific gas concentration can be detected correctly). This time is called “light-off time”. The light-off time varies depending on the length of time required to pump out oxygen that is present before the sensor element 101 is used (oxygen not derived from the specific gas) in the third internal cavity 61 where the measurement electrode 44 is located, to a level that does not affect the measurement accuracy. In the sensor element 101 of the present embodiment, by setting the volume ratio Fv to 0.21 or less, the light-off time of the measurement electrode 44 can be suppressed from becoming longer. The present inventors have demonstrated this fact through experiments, analyses, and the like. The reason for this is considered to be as follows. The larger the volume ratio Fv of the sensor element 101, the larger the volume Ve of the measurement electrode 44 is relative to the volume (Vr−Ve) of the space portion in the third internal cavity 61. Therefore, a height of the measurement electrode 44 tends to become higher or a space between a surface of the measurement electrode 44 and the inner surface of the third internal cavity 61 tends to become narrower. If the height of the measurement electrode 44 becomes too high, a time required for oxygen ions to move in the height direction inside the measurement electrode 44 becomes longer, and thus the light-off time becomes longer. If the space between the surface of the measurement electrode 44 and the inner surface of the third internal cavity 61 becomes too narrow, a speed at which the measurement electrode 44 pumps out oxygen in the third internal cavity 61, i.e., a pumping speed of the measurement pump cell 41, becomes slow, and thus the light-off time becomes longer. From the above, the light-off time tends to be longer for sensor elements 101 with a larger volume ratio Fv. In contrast, When the volume ratio Fv is 0.21 or less, the height of the measurement electrode 44 is prevented from becoming too high, or the space between the surface of the measurement electrode 44 and the inner surface of the third internal cavity 61 is prevented from becoming too narrow, thereby preventing the light-off time from becoming longer.

As described above, the sensor element 101 of present embodiment satisfies 0.05≤Fv≤0.21, thereby suppressing the light-off time from becoming longer while suppressing deterioration of the measurement electrode 44.

In the sensor element 101, when a height direction is defined as the direction perpendicular to a arrangement surface of the measurement electrode 44 in the third internal cavity 61, a height of the measurement electrode 44 is defined as He [mm], a height of the third internal cavity 61 is defined as Hr [mm], and a height ratio is defined as Fh=He/Hr, it is preferable that Fh<0.3 is satisfied. the area of the contact surface of the measurement electrode 44 with the arrangement surface is defined as Se [mm²], an area of the arrangement surface is defined as Sr [mm²], and an area ratio is defined as Sh=Se/Sr, it is preferable that Sh<0.8 is satisfied. In the present embodiment, as illustrated in FIG. 1 and FIG. 2, a lower surface of the inner surface of the third internal cavity 61 is the arrangement surface of the measurement electrode 44, so the height direction is the direction perpendicular to this lower surface, i.e., the up-down direction. In addition, the lower surface of the measurement electrode 44 is the contact surface of the measurement electrode 44 with the arrangement surface. If the height ratio Fh is less than 0.3, the height He of the measurement electrode 44 can be prevented from becoming too high. In addition, if the area ratio Sh is less than 0.8, the area of the lower surface of the measurement electrode 44, i.e., the area of the contact surface Se, is not too large compared to the area of the lower surface of the third internal cavity 61, i.e., the area Sr of the arrangement surface, so that the space between the surface of the measurement electrode 44 (here, in particular, the front, rear, left, and right surfaces of the measurement electrode 44) and the inner surface of the third internal cavity 61 can be prevented from becoming too narrow. As described above, if the height He of the measurement electrode 44 becomes too high or the space between the surface of the measurement electrode 44 and the inner surface of the third internal cavity 61 becomes too narrow, the light-off time becomes longer, but by satisfying Fh<0.3 and Sh<0.8, it is possible to more reliably suppress the light-off time from becoming longer. The present inventors have demonstrated this fact through experiments, analyses, and the like. The height He of the measurement electrode 44 may be, for example, 0.005 mm or more and 0.05 mm or less. The height Hr of the third internal cavity 61 may be, for example, 0.05 mm or more and 0.25 mm or less. The area Se of the measurement electrode 44 may be, for example, 0.2 mm² or more and 1.0 mm² or less. The area Sr of the third internal cavity 61 may be, for example, 0.6 mm² or more and 2.0 mm² or less.

In the sensor element 101, it is preferable that only one surface of the measurement electrode 44 is in contact with the inner surface of the third internal cavity 61. In this way, compared to when two or more surfaces of the measurement electrode 44 are in contact with the inner surface of the third internal cavity 61, the area of the measurement electrode 44 exposed inside the third internal cavity 61 is larger, thereby increasing the oxygen pumping speed of the measurement pump cell 41. Therefore, oxygen present in the third internal cavity 61 before the start-up of the sensor element 101 can be removed from the third internal cavity 61 in a shorter time, and it is possible to further suppress the light-off time from becoming longer. In the present embodiment, as illustrated in FIG. 1 and FIG. 2, only the lower surface of the measurement electrode 44 is in contact with the inner surface of the third internal cavity 61, and the front, rear, left, and right surfaces and the upper surface of the measurement electrode 44 are separated from the inner surface of the third internal cavity 61. Therefore, it is possible to further suppress the light-off time from becoming longer.

Here, the correspondence relationships between the components in the present embodiment and the components in the present invention will now be clarified. The first substrate layer 1, the second substrate layer 2, the third substrate layer 3, the first solid electrolyte layer 4, the spacer layer 5, and the second solid electrolyte layer 6 according to the present embodiment each correspond to the solid electrolyte layer according to the present invention. The element body 102 corresponds to the element body. The first and second internal cavities 20 and 40 correspond to the oxygen concentration adjustment chamber, the inner pump electrode 22 and the auxiliary pump electrode 51 correspond to the inner adjustment electrode, the main pump cell 21 and the auxiliary pump cell 50 correspond to the adjustment pump cell, the third internal cavity 61 corresponds to the measurement chamber, and the measurement electrode 44 corresponds to the measurement electrode. and the measurement pump cell 41 corresponds to the measurement pump cell.

In the sensor element 101 included in the gas sensor 100 according to the present embodiment described in detail above, the volume ratio Fv between the measurement electrode 44 and the third internal cavity 61 satisfies 0.05≤Fv≤0.21. By setting the volume ratio Fv to 0.05 or more, the deterioration of the measurement electrode 44 can be suppressed. By setting the volume ratio Fv to 0.21 or less, the light-off time of the sensor element 101 can be suppressed from becoming longer.

In addition, in the sensor element 101, the height ratio Fh between the measurement electrode 44 and the third internal cavity 61 satisfies Fh<0.3 and it is satisfied that the area ratio Sh<0.8. In this way, it is possible to more reliably suppress the light-off time from becoming longer.

Furthermore, in the sensor element 101, only one surface of the measurement electrode 44 is in contact with the inner surface of the third internal cavity 61. In this way, it is possible to further suppress the light-off time from becoming longer.

Note that the present invention is not limited to the above-described embodiment at all, and may be, of course, implemented in various modes within the technical scope of the present invention.

For example, in the above embodiment, only one surface of the measurement electrode 44 is in contact with the inner surface of the third internal cavity 61, but this is not limited to thereto. For example, two or more surfaces of the measurement electrode 44 may be in contact with the inner surface of the third internal cavity 61, such as the lower surface and the right surface of the measurement electrode 44 being in contact with the inner surface of the third internal cavity 61. When two or more surfaces of the measurement electrodes 44 are in contact with the inner surfaces of the third internal cavity 61 (when there are two or more arrangement surfaces), the height ratio Fh is calculated for each arrangement surface on which the measurement electrodes 44 are arranged. For example, when the lower surface and the right surface of the measurement electrodes 44 are in contact with the inner surfaces of the third internal cavity 61, the length of the measurement electrode 44 in the up-down direction is set as the height Hea, the length of the measurement electrode 44 in the left-right direction is set as the height Heb, the length of the third internal cavity 61 in the up-down direction is set as the height Hra, the length of the third internal cavity 61 in the left-right direction is set as the height Hrb, the height ratio Fha=Hea/Hra is set, and the height ratio Fhb=Heb/Hrb is set. In this case, it is preferable that at least one of the height ratios Fha and Fhb is less than 0.3, and it is more preferable that both are less than 0.3. Similarly, when two or more surfaces of the measurement electrodes 44 are in contact with the inner surface of the third internal cavity 61 (when there are two or more arrangement surfaces), the area ratio Sh is calculated for each arrangement surface on which the measurement electrodes 44 are arranged. It is preferable that at least one of a plurality of the area ratios calculated for each arrangement surface is less than 0.8, and it is more preferable that all of them are less than 0.8.

In the above embodiment, only one measurement electrode 44 was provided in the third internal cavity 61, but two or more measurement electrodes 44 may be provided. For example, the sensor element 101 may include, in addition to the measurement electrode 44 provided on the lower surface of the inner surface of the third internal cavity 61 as shown in FIG. 1, a measurement electrode 44 provided on the upper surface of the inner surface of the third internal cavity 61. When a plurality of measurement electrodes 44 are provided, it is preferable that at least one of the plurality of measurement electrodes 44 is in contact with the inner surface of the third internal cavity 61 with only one surface. It is more preferable that all of the plurality of measurement electrodes 44 are in contact with the inner surface of the third internal cavity 61 with only one surface. When the sensor element 101 includes the plurality of measurement electrodes 44, the total volume of the plurality of measurement electrodes 44 is defined as the volume Ve. When the sensor element 101 includes the plurality of measurement electrodes 44, the height ratio Fh is calculated for each of the plurality of measurement electrodes 44, and it is preferable that each height ratio Fh is less than 0.3. For example, when the sensor element 101 includes a first measurement electrode disposed on the lower surface of the inner surface of the third internal cavity 61 and a second measurement electrode disposed on the upper surface of the inner surface of the third internal cavity 61, a height of the first measurement electrode is set to He1, a height of the second measurement electrode is set to He2, a height ratio Fh1=He1/Hr is set, and a height ratio Fh2=He2/Hr is set. In this case, it is preferable that at least one of the height ratios Fh1 and Fh2 be less than 0.3, and it is more preferable that both be less than 0.3. When the sensor element 101 includes the plurality of measurement electrodes 44, the area ratio Sh is calculated for each of the plurality of measurement electrodes 44 for each arrangement surface, and it is preferable that at least one of the calculated plurality of area ratios Sh is less than 0.8, and it is more preferable that all of them are less than 0.8.

In the above embodiment, both of the measurement electrode 44 and the third internal cavity 61 has the substantially rectangular parallelepiped shape, but they are not limited to this shape. For example, the measurement electrode 44 may have a columnar shape.

While the oxygen-concentration adjustment chamber according to the above embodiment includes the first internal cavity 20 and the second internal cavity 40, such an embodiment is not limiting. For example, the oxygen-concentration adjustment chamber may further include another internal cavity, or one of the first internal cavity 20 and the second internal cavity 40 may be omitted. Likewise, while the adjustment pump cell according to the above embodiment includes the main pump cell 21 and the auxiliary pump cell 50, such an embodiment is not limiting. For example, the adjustment pump cell may further include another pump cell, or one of the main pump cell 21 and the auxiliary pump cell 50 may be omitted. For example, if the oxygen concentration in the measurement-object gas can be satisfactorily reduced by using the main pump cell 21 alone, the auxiliary pump cell 50 may be omitted. If the auxiliary pump cell 50 is omitted, the controller 96 only needs to perform the main-pump control process as the adjustment-pump control process. Furthermore, in the main-pump control process, the setting of the target value V0* based on the pump current Ip1 described above may be omitted. Specifically, if a predetermined target value V0* is preliminarily stored in the storage unit 98, the controller 96 only needs to control the main pump cell 21 by performing feedback control on the voltage Vp0 of the variable power source 24 such that the voltage V0 becomes the target value V0*.

In the embodiment described above, the outer pump electrode 23 plays a role as the electrode (also referred to as an outer main pump electrode) to be paired with the inner pump electrode 22 in the main pump cell 21, plays a role as the electrode (also referred to as an outer auxiliary pump electrode) to be paired with the auxiliary pump electrode 51 in the auxiliary pump cell 50, and plays a role as the electrode (also referred to as an outer measurement electrode) to be paired with the measurement electrode 44 in the measurement pump cell 41; however, the present invention is not limited thereto. One or more of the outer main pump electrodes, the outer auxiliary pump electrode, and the outer measurement electrode may be provided separately from the outer pump electrode 23 on outer surface of the element body so 102 as to be in contact with the measurement-object gas.

While the sensor element 101 according to the above embodiment is configured to detect the concentration of NOx in the measurement-object gas, such an embodiment is not limiting as long as the sensor element is configured to detect the concentration of any specific gas in the measurement-object gas. For example, the concentration of any oxide other than NOx may be defined as the specific gas concentration. If the specific gas is an oxide, oxygen is produced when the specific gas itself is reduced in the third internal cavity 61, as with the case of the above embodiment. Therefore, the measurement pump cell 41 can detect the specific gas concentration by acquiring a value (for example, the pump current Ip2) detected in correspondence with the oxygen. Alternatively, the specific gas may be a non-oxide, such as ammonia. If the specific gas is a non-oxide, the specific gas is converted into an oxide (e.g., into NO in the case of ammonia), so that oxygen is produced when the converted gas is reduced in the third internal cavity 61. Thus, the measurement pump cell 41 can acquire a value (e.g., the pump current Ip2) detected in correspondence with this oxygen and thus detect the specific gas concentration. For example, since the inner pump electrode 22 in the first internal cavity 20 functions as a catalyst, the ammonia is converted into NO in the first internal cavity 20.

In the above-described embodiment, the element body 102 of the sensor element 101 is a layered body having a plurality of solid electrolyte layers (layers 1 to 6), but is not limited thereto. The element body 102 of the sensor element 101 may include at least one oxygen-ion-conductive solid electrolyte layer. For example, in FIG. 1, the layers 1 to 5 other than the second solid electrolyte layer 6 may be layers (e.g., layers composed of alumina) composed of a material other than solid electrolyte. In this case, the electrodes of the sensor element 101 may be disposed in the second solid electrolyte layer 6. For example, the measurement electrode 44 in FIG. 1 may be disposed on the lower surface of the second solid electrolyte layer 6. Also, the reference gas inlet space 43 may be provided in the spacer layer 5 instead of the first solid electrolyte layer 4, the reference gas inlet layer 48 may be provided between the second solid electrolyte layer 6 and the spacer layer 5 instead of between the first solid electrolyte layer 4 and the third substrate layer 3, and the reference electrode 42 may be provided rearward of the third internal cavity 61 and on the lower surface of the second solid electrolyte layer 6.

In the above embodiment, the controller 96 sets (i.e., performs feedback control on) the target value V0* of the voltage V0 based on the pump current Ip1 so as to set the pump current Ip1 to the target value Ip1*, and performs feedback control on the pump voltage Vp0 so as to set the voltage V0 to the target value V0*, but may perform another type of control. For example, the controller 96 may perform feedback control on the pump voltage Vp0 based on the pump current Ip1 so as to set the pump current Ip1 to the target value Ip1*. Specifically, the controller 96 may omit the acquisition of the voltage V0 from the main-pump-control oxygen-partial-pressure detection sensor cell 80 and the setting of the target value V0*, and may directly control the pump voltage Vp0 (and by extension the pump current Ip0) based on the pump current Ip1.

Specifically fabricated examples of the sensor element will now be described. Note that the present invention is not limited to the following examples.

### Experimental Examples 1 to 40

Experimental Example 1 was obtained by fabricating the sensor element 101 illustrated in FIGS. 1 and 2, using the manufacturing method described above. In fabricating the sensor element 101, ceramic green sheets were each obtained by mixing zirconia particles having 4 mol % of yttria added thereto as a stabilizer with an organic binder and an organic solvent, and then molding the mixture by tape molding. The measurement electrode 44 was made of a porous cermet electrode composed of Pt, Rh, and ZrO₂. Experimental Examples 2 to 40 were fabricated by the same manufacturing method. In all of Experimental Examples 1 to 40, the porosity P of the measurement electrode 44 was set to 25%. In Experimental Examples 1 to 40, the volume Ve of the measurement electrode 44 was varied in the range of 0.003 mm³ to 0.016 mm³, and the volume Vr of the third internal cavity 61 was varied in the range of 0.06 mm³ to 0.08 mm³. As a result, the volume ratio Fv in Experimental Examples 1 to 40 was changed in the range of 0.044 to 0.245.

### Experimental Examples 41 to 168

Experimental Examples 41 to 168 were fabricated by the same manufacturing method as in Experimental Example 1. In all of Experimental Examples 41 to 168, the porosity P of the measurement electrode 44 was set to 25%. In Experimental Examples 41 to 168, the volume Ve of the measurement electrode 44 was varied in the range of 0.001 mm³ to 0.016 mm³, and the volume Vr of the third internal cavity 61 was varied in the range of 0.071 mm³ to 0.085 mm³. As a result, the volume ratio Fv in Experimental Examples 41 to 168 was varied in the range of 0.015 to 0.220.

### [Evaluation Test 1]

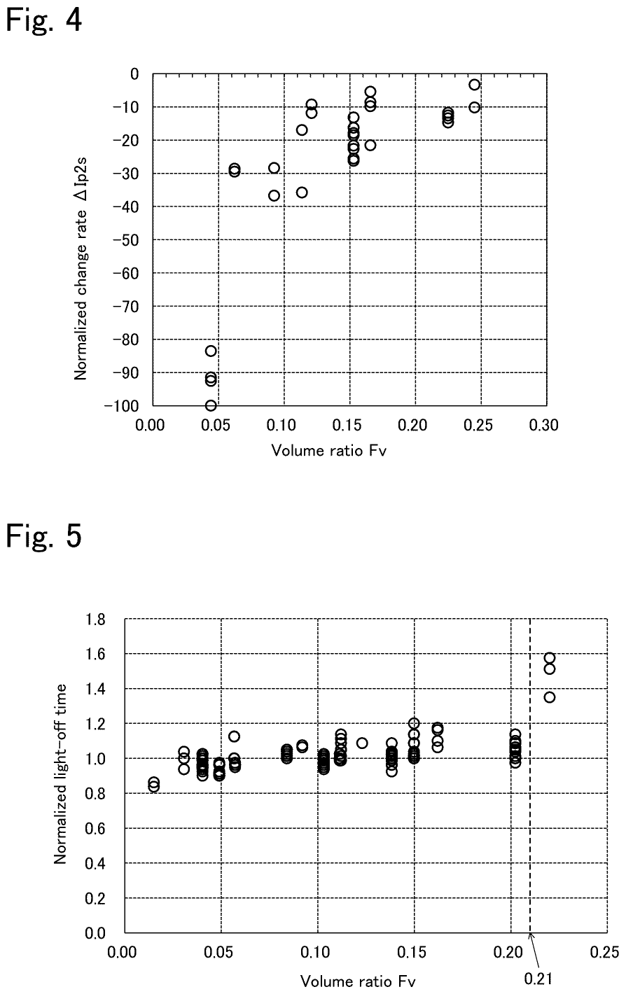

A durability test was carried out on each of Experimental Examples 1 to 40 using a diesel engine, and a degree of deterioration of the measuring electrode 44 after the durability test was evaluated. First, the gas sensor 100 including the sensor element 101 of Experimental Example 1 was attached to a pipe so that the tip end portion of the sensor element 101 protruded into the pipe. Then, the sensor element 101 was heated by the heater control process so that the temperature of the heater 72 became 800° C. In this state, a model gas was prepared with nitrogen as the base gas, an oxygen concentration of 21%, a NOx concentration of 2000 ppm, and a pressure of 1 atm, and this was flowed into the pipe as the measurement-object gas. Then, for Experimental Example 1, the adjustment-pump control process and the measurement-pump control process were performed, and the pump current Ip2 was allowed to stabilize. The pump current Ip2 after stabilization was measured as the pump current Ip2 before the durability test. Next, the durability test was performed as follows. First, the gas sensor 100 of Experimental Example 1 was attached to a pipe of the exhaust gas pipe of the diesel engine. Then, the diesel engine was operated at a predetermined operating pattern, and the adjustment-pump control process and the measurement-pump control process were performed continuously for 2,000 hours. After the 2,000-hour durability test, the gas sensor was removed from the exhaust pipe and attached to a model gas apparatus, and a value of the pump current Ip2 was measured in the same manner as before the durability test, and this was taken as the pump current Ip2 after the durability test. Then, the change rate ΔIp2 [%] of the pump current Ip2 after the durability test relative to the pump current Ip2 before the durability test was calculated. Specifically, the value obtained by subtracting the pump current Ip2 before the durability test from the pump current Ip2 after the durability test was divided by the pump current Ip2 before the durability test to calculate the change rate ΔIp2 [%]. The change rate ΔIp2 is a negative value. The change rate ΔIp2 was calculated for Experimental Examples 2 to 40 in the same manner. Furthermore, the smallest value (the value with the largest absolute value) among the change rates Δ Ip2 of Experimental Examples 1 to 40 was normalized as −100[%] to obtain normalized change rates ΔIp2s. A graph showing the relationship between the volume ratio Fv and the normalized change rate ΔIp2s for Experimental Examples 1 to 40 is illustrated in FIG. 4. Here, when the measurement electrode 44 deteriorates and the catalyst activity decreases, the accuracy in detection of the NOx concentration decreases, so the normalized change rate Δ Ip2s becomes small (the absolute value becomes large). Therefore, it can be determined that the deterioration of the measurement electrode 44 after the durability test is suppressed when the normalized change rate ΔIp2s is large (the absolute value is small).

### [Evaluation Test 2]

The light-off time of the sensor elements in Experimental Examples 41 to 168 was evaluated. First, a gas sensor 100 including the sensor element 101 of Experimental Example 41 was attached to a pipe so that the tip end portion of the sensor element 101 protruded into the pipe. Next, in a state where the inside of the pipe was in an atmosphere, a sufficient amount of time was allowed to elapse, so that the third internal cavity 61 became an atmosphere. Next, a model gas was prepared with nitrogen as the base gas, an oxygen concentration of 0%, a NOx concentration of 100 ppm, and a pressure of 1 atm, and this was flowed into the pipe as the measurement-object gas. At the same time, the heater control process was started, and when the heater 72 reached 800° C., the adjustment-pump control process and the measurement-pump control process were started. Then, the time from the start of the heater control processing to the time when the pump current Ip2 became a value corresponding to a NOx concentration of 2000 ppm±10 ppm was measured as the light-off time. The light-off time was measured in the same manner for Experimental Examples 42 to 168. Furthermore, the light-off time of one of the experimental examples 41 to 168 was normalized as 1.0 to obtain normalized light-off times. A graph showing the relationship between the volume ratio Fv and the normalized light-off time for Experimental Examples 41 to 168 is illustrated in FIG. 5. A smaller normalized light-off time means a shorter light-off time.

As can be seen from FIG. 4, among Experimental Examples 1 to 40, those with a volume ratio Fv of 0.05 or more had a sufficiently small absolute value of the normalized change rate ΔIp2s compared to those with a volume ratio Fv of less than 0.05. Therefore, it was confirmed that the deterioration of the measurement electrode 44 after the durability test could be suppressed by having a volume ratio Fv of 0.05 or more. As can be seen in FIG. 5, among experimental examples 41 to 168, those with the volume ratio Fv of 0.21 or less had the normalized light-off time that was sufficiently shorter than those with a volume ratio Fv greater than 0.21. Therefore, it was confirmed that the volume ratio Fv of 0.21 or less suppresses the light-off time from becoming longer.

What is claimed is:

1. A sensor element for detecting a concentration of a specific gas in a measurement-object gas, the sensor element comprising:
an element body including an oxygen-ion-conductive solid electrolyte layer, and including a measurement-object gas flow section inside that introduces the measurement-object gas and allows the measurement-object gas to flow through;
an adjustment pump cell including an inner adjustment electrode provided in an oxygen concentration adjustment chamber of the measurement-object gas flow section, and being configured to adjust an oxygen concentration in the oxygen concentration adjustment chamber; and
a measurement pump cell including a measurement electrode provided in a measurement chamber that is located downstream of the oxygen concentration adjustment chamber in the measurement-object gas flow section, and adjusting an oxygen concentration in the measurement chamber;
wherein, letting Ve [mm³] be a volume of the measurement electrode, and Vr [mm³] be a volume of the measurement chamber, and defining a volume ratio as Fv=Ve/(Vr−Ve), 0.05≤Fv≤0.21 is satisfied.

2. The sensor element according to claim 1,
wherein, letting a height direction be a direction perpendicular to an arrangement surface on which the measurement electrode is arranged in the measurement chamber, He [mm] be a height of the measurement electrode, and Hr [mm] be a height of the measurement chamber, and defining a height ratio as Fh=He/Hr, Fh<0.3 is satisfied, and
letting Se [mm³] be an area of the contact surface of the measurement electrode with the arrangement surface, Sr [mm³] be an area of the arrangement surface, and defining an area ratio as Sh=Se/Sr, Sh<0.8 is satisfied.

3. The sensor element according to claim 1,
wherein only one surface of the measurement electrode is in contact with an inner surface of the measurement chamber.

4. The sensor element according to claim 1,
wherein the measurement electrode is a porous body, and
letting Ve′ [mm³] be a volume based on the external dimensions of the measurement electrode, P [%] be a porosity of the measurement electrode, the volume Ve is expressed as Ve=Ve′*(1−P/100).

5. The sensor element according to claim 1,
wherein the measurement electrode contains at least one of Pt or Rh.

6. The sensor element according to claim 1,
wherein the oxygen concentration adjustment chamber includes a first internal cavity, and a second internal cavity provided downstream of the first internal cavity;
the inner adjustment electrode includes a main pump electrode provided in the first internal cavity, and an auxiliary pump electrode provided in the second internal cavity; and
the adjustment pump cell includes a main pump cell having the main pump electrode and being configured to adjust an oxygen concentration in the first internal cavity, and an auxiliary pump cell having the auxiliary pump electrode and being configured to adjust an oxygen concentration in the second internal cavity.

7. A gas sensor comprising the sensor element according to claim 1.
